(19) United States
(12) Patent Application Publication
(10) Pub. No.: US 2011/0161783 A1
(43) Pub. Date: Jun. 30, 2011

(54) METHOD AND APPARATUS ON DIRECT MATCHING OF CACHE TAGS CODED WITH ERROR CORRECTING CODES (ECC)

(76) Inventors: Dinesh Somasekhar, Portland, OR (US); Jeffrey L. Miller, Vancouver, WA (US); Gunjan H. Pandya, Portland, OR (US); Tsung-Yung Chang, Cupertino, CA (US); Wei Wu, Portland, OR (US); Shih-Lien L. Lu, Portland, OR (US)

(21) Appl. No.: 12/647,932

(22) Filed: Dec. 28, 2009

(51) Int. Cl. G06F 11/10; G06F 12/06

(52) U.S. Cl. 714/768; 711/105; 711/E12.078; 714/E11.044

(57) ABSTRACT

An apparatus and method is described herein directly matching coded tags. An incoming tag address is encoded with error correction codes (ECCs) to obtain a coded, incoming tag. The coded, incoming tag is directly compared to a stored, coded tag; this comparison result, in one example, yields an m-bit difference between the coded, incoming tag and the stored, coded tag. ECC, in one described embodiment, is able to correct k-bits and detect k+1 bits. As a result, if the m-bit difference is within 2k+2 bits, then valid codes—coded tags—are detected. As an example, if the m-bit difference is less than a hit threshold, such as k-bits, then a hit is determined, while if the m-bit difference is greater than a miss threshold, such as k+1 bits, then a miss is determined.

### FIELD

This invention relates to the field of processors and, in particular, to optimizing cache memory accesses.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores, multiple hardware threads, and multiple logical processors present on individual integrated circuits. A processor or integrated circuit typically comprises a single physical processor die, where the processor die may include any number of cores, hardware threads, or logical processors.

The ever increasing number of processing elements—cores, hardware threads, and logical processors—on integrated circuits enables more tasks to be accomplished in parallel. However, as the number of tasks being performed in parallel grows, the need for accesses to processor caches to be serviced quickly and efficiently has also escalated. Cache memories are typically organized into a data array and tag directory, wherein the tag directory includes address information—often referred to as a tag or tag address—to indicate what data is in the data portion of the cache. For example, upon a read from the cache, the tag directory is compared with a tag portion of an incoming address referenced by the read. If the comparison indicates that the same incoming tag portion is resident in the tag directory and the status field for the resident entry indicates it's valid, then a “hit” has occurred.

Yet, as processor complexity has increased, so has the size and complexity of its data and instruction caches. Therefore, more recently, designers have been including Error Correction Codes (ECCs) in tag information, data information, or both to protect the information against errors due to environmental events and circuit stability. An error in the tag has two possible results: (1) it may indicate a hit while the actual data is not in the cache, which is dangerous because erroneous data could enter the system without any warning; or (2) it may indicate a miss while the actual data is in the cache, which appears to be harmless and affects only the performance. However, if the data in the cache has been modified, the error of the second type potentially causes stale data to be read from higher-level memory in a memory hierarchy. Once again the stale data may then be utilized and incorrect data is proliferated through out the system without warning.

ECC allows the tag/data to have up to a fixed number of errors and recover from these errors. A common ECC implementation is usually called Single bit Error Correction and Double bit Error Detection (SECDED). When a tag directory is protected by ECC, the tag comparison to determine if a hit has occurred is quite cumbersome. Here, the coded tag—containing both the tag information and ECC check bits—are first read from the tag directory. Previously, ECC logic then extracts the correct tag information from the coded tag by checking and correcting—if required—the tag before comparison to the incoming address tag. For example, a syndrome checker determines if an error exists based on the ECC check bits. If a correctable error exits, then the stored tag information is corrected before comparison. After extraction—check and potential correction—then the stored tag is compared to the incoming tag. However, inclusion of checking and potential correction in the critical path of a cache lookup may result in degraded performance due to the length of the critical path. Furthermore, many modern caches include a set associative organization—multiple ways capable of holding data from a single address—which may necessitate this error checking and correction circuit for each way of the cache; this is potentially expensive and incurs a large ECC overhead.

### BRIEF DESCRIPTION OF THE DRAWINGS

The present invention is illustrated by way of example and not intended to be limited by the figures of the accompanying drawings.

FIG. 1 illustrates an embodiment of a processor including multiple processing elements.

FIG. 2 illustrates another embodiment of a processor including multiple processing elements.

FIG. 3 illustrates an embodiment of a cache memory capable of directly matching coded tags.

FIG. 4 illustrates an embodiment of a cache control mechanism of FIG. 3.

FIG. 5 illustrates an embodiment of comparison, difference logic from FIG. 4.

FIG. 6 illustrates an embodiment of a flow diagram for a method of performing a cache lookup utilizing coded tags.

### DETAILED DESCRIPTION

In the following description, numerous specific details are set forth such as examples of specific hardware structures/mechanisms for cache memories, tag directories, comparison circuits; specific processor configurations; specific numbers of errors detected/corrected by error correction codes; specific bit difference thresholds for hits, misses, and faults; specific processor units/logic; specific examples of processing elements; etc. in order to provide a thorough understanding of the present invention. It will be apparent, however, to one skilled in the art that these specific details need not be employed to practice the present invention. In other instances, well known components or methods, such as specific and alternative multi-core and multi-threaded processor architectures, specific logic circuits/code for error correction logic, specific cache organizations, specific operational details of tag directories and data arrays, specific encoding of tags with error correction information, and specific operational details of microprocessors haven't been described in detail in order to avoid unnecessarily obscuring the present invention.

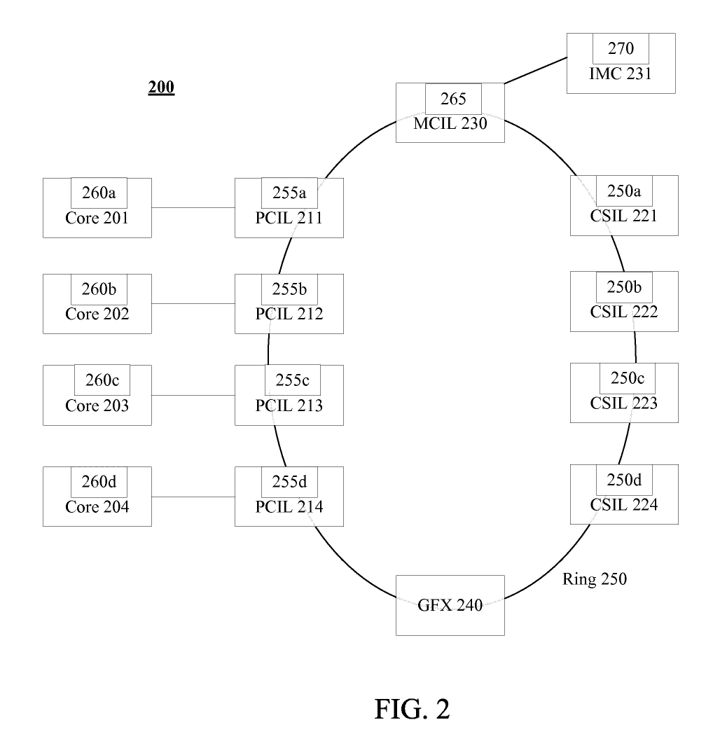

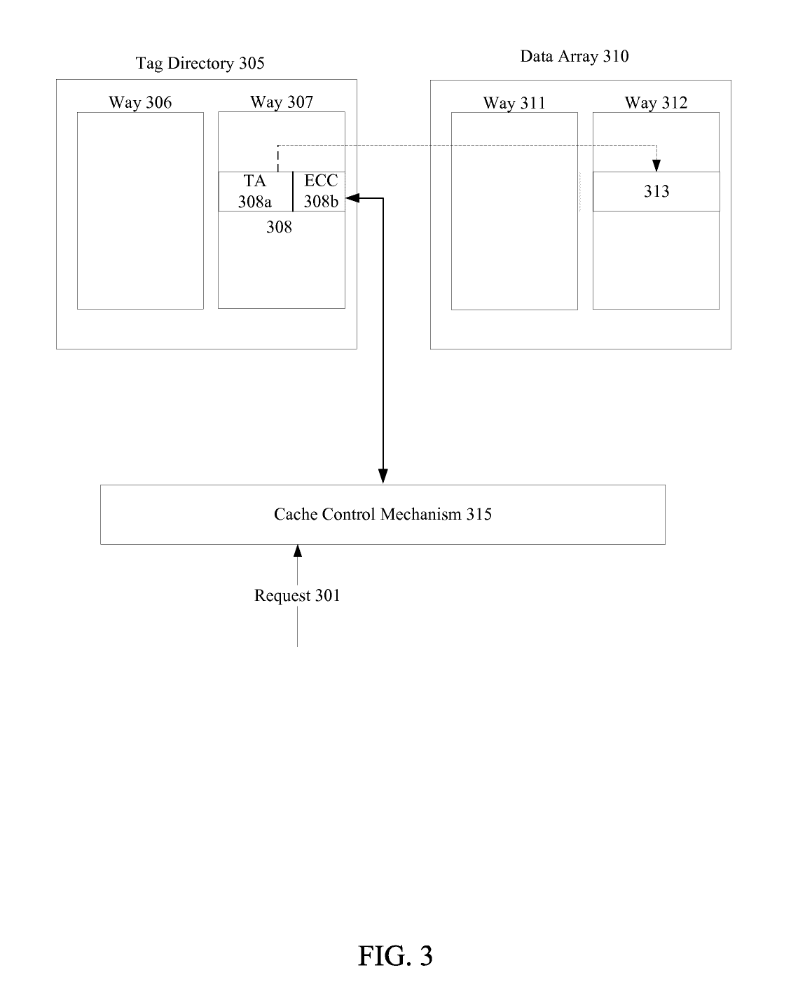

The method and apparatus described herein are for directly matching cache tags with encoded error correcting information. Specifically, these cache lookup optimizations are discussed primarily in reference to caches in a microprocessor. In fact, an illustrative microprocessor embodiments are briefly described below in reference to FIGS. 2 and 3. Yet, the apparatus' and methods described herein are not so limited, as they may be implemented in any integrated circuit including a memory employing encoding of stored information with error correction information that is to be matched with incoming information. Furthermore, direct matching of stored, coded information and incoming information is not limited to tags including ECCs, but rather may also include direct matching of elements coded with any information, such as timestamps, clock information, and metadata.

### Embodiments of Multi-Processing Element Processors

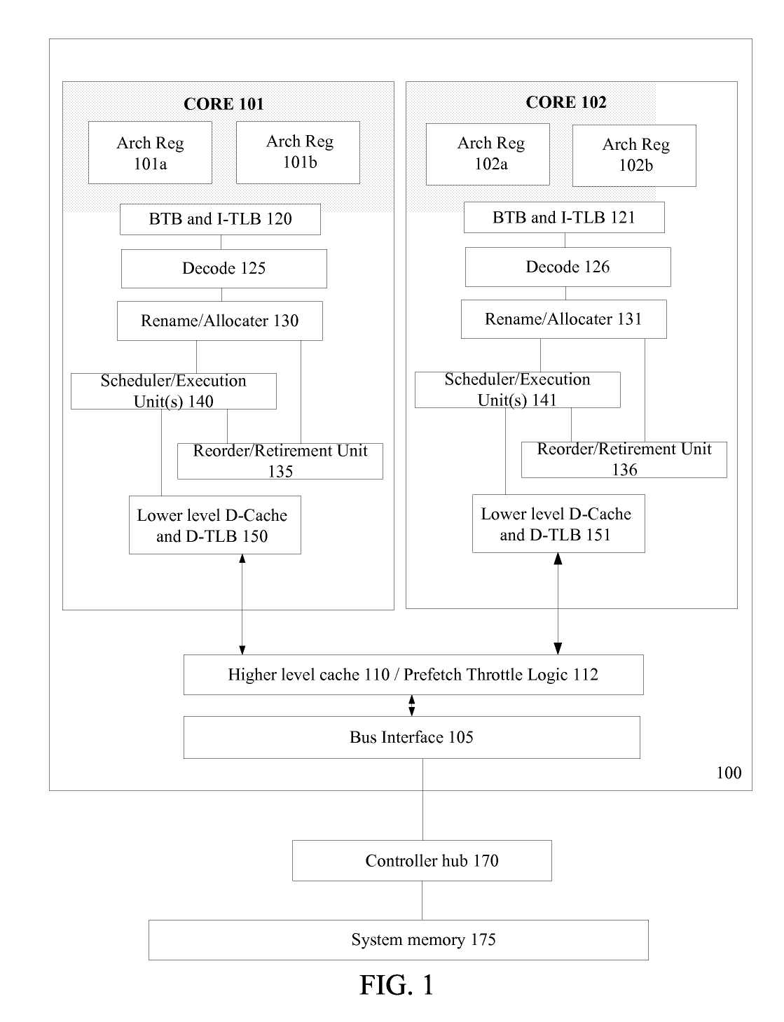

Referring to FIG. 1, an embodiment of a processor including multiple cores is illustrated. Processor 100, in one embodiment, includes one or more caches capable of directly matching encoded tags—encoded with error correction information—without first decoding error correcting information in a stored, coded tag. Processor 100 includes any processor, such as a micro-processor, an embedded processor, a digital signal processor (DSP), a network processor, or other device to execute code. Processor 100, as illustrated, includes a plurality of processing elements.

In one embodiment, a processing element refers to a thread unit, a thread slot, a process unit, a context, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state wherein each independently maintained architectural state is associated with at least some dedicated execution resources. In contrast to cores, a hardware thread typically refers to any logic located on an integrated circuit capable of maintaining an independent architectural state wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores, core 101 and 102. Here, core hopping may be utilized to alleviate thermal conditions on one part of a processor. However, hopping from core 101 to 102 may potentially create the same thermal conditions on core 102 that existed on core 101, while incurring the cost of a core hop. Therefore, in one embodiment, processor 100 includes any number of cores that may utilize core hopping. Furthermore, power management hardware included in processor 100 may be capable of placing individual units and/or cores into low power states to save power. Here, in one embodiment, processor 100 provides hardware to assist in low power state selection for these individual units and/or cores.

Although processor 100 may include asymmetric cores, i.e. cores with different configurations, functional units, and/or logic, symmetric cores are illustrated. As a result, core 102, which is illustrated as identical to core 101, will not be discussed in detail to avoid repetitive discussion. In addition, core 101 includes two hardware threads 101a and 101b, while core 102 includes two hardware threads 102a and 102b. Therefore, software entities, such as an operating system, potentially view processor 100 as four separate processors, i.e. four logical processors or processing elements capable of executing four software threads concurrently.

Here, a first thread is associated with architecture state registers 101a, a second thread is associated with architecture state registers 101b, a third thread is associated with architecture state registers 102a, and a fourth thread is associated with architecture state registers 102b. As illustrated, architecture state registers 101a are replicated in architecture state registers 101b, so individual architecture states/contexts are capable of being stored for logical processor 101a and logical processor 101b. Other smaller resources, such as instruction pointers and renaming logic in rename allocater logic 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register, low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, processor 100 includes a branch target buffer 120 to predict branches to be executed/taken and an instruction-translation buffer (I-TLB) 120 to store address translation entries for instructions.

Processor 100 further includes decode module 125 is coupled to fetch unit 120 to decode fetched elements. In one embodiment, processor 100 is associated with an Instruction Set Architecture (ISA), which defines/specifies instructions executable on processor 100. Here, often machine code instructions recognized by the ISA include a portion of the instruction referred to as an opcode, which references/specifies an instruction or operation to be performed.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

As depicted, cores 101 and 102 share access to higher-level or further-out cache 110, which is to cache recently fetched elements. Note that higher-level or further-out refers to cache levels increasing or getting further way from the execution unit(s). In one embodiment, higher-level cache 110 is a last-level data cache—last cache in the memory hierarchy on processor 100—such as a second or third level data cache. However, higher level cache 110 is not so limited, as it may be associated with or include an instruction cache. A trace cache—a type of instruction cache—instead may be coupled after decoder 125 to store recently decoded traces.

Note, in the depicted configuration that processor 100 also includes bus interface module 105 to communicate with devices external to processor 100, such as system memory 175, a chipset, a northbridge, or other integrated circuit. Memory 175 may be dedicated to processor 100 or shared with other devices in a system. Common examples of types of memory 175 include dynamic random access memory (DRAM), static RAM (SRAM), non-volatile memory (NV memory), and other known storage devices.

FIG. 1 illustrates an abstracted, logical view of an exemplary processor with a representation of different modules, units, and/or logic. However, note that a processor utilizing the methods and apparatus' described herein need not include the illustrated units. And, the processor may omit some or all of the units shown. To illustrate the potential for a different configuration, the discussion now turns to FIG. 2, which depicts an embodiment of processor 200 including an on-processor memory interface module—an uncore module—with a ring configuration to interconnect multiple cores. Processor 200 is illustrated including a physically distributed cache; a ring interconnect; as well as core, cache, and memory controller components. However, this depiction is purely illustrative, as a processor implementing the described methods and apparatus may include any processing elements, style or level of cache, and/or memory, front-side-bus or other interface to communicate with external devices.

In one embodiment, caching agents 221-224 are each to manage a slice of a physically distributed cache. As an example, each cache component, such as component 221, is to manage a slice of a cache for a collocated core—a core the cache agent is associated with for purpose of managing the distributed slice of the cache. As depicted, cache agents 221-224 are referred to as Cache Slice Interface Logic (CSIL)s; they may also be referred to as cache components, agents, or other known logic, units, or modules for interfacing with a cache or slice thereof. Note that the cache may be any level of cache; yet, for this exemplary embodiment, discussion focuses on a last-level cache (LLC) shared by cores 201-204.

Much like cache agents handle traffic on ring interconnect 250 and interface with cache slices, core agents/components 211-214 are to handle traffic and interface with cores 201-204, respectively. As depicted, core agents 221-224 are referred to as Processor Core Interface Logic (PCIL)s; they may also be referred to as core components, agents, or other known logic, units, or modules for interfacing with a processing element Additionally, ring 250 is shown as including Memory Controller Interface Logic (MCIL) 230 and Graphics Hub (GFX) 240 to interface with other modules, such as memory controller (IMC) 231 and a graphics processor (not illustrated). However, ring 250 may include or omit any of the aforementioned modules, as well as include other known processor modules that are not illustrated. Additionally, similar modules may be connected through other known interconnects, such as a point-to-point interconnect or a multi-drop interconnect.

It's important to note that the methods and apparatus' described herein may be implemented in any cache at any cache level. For example, direct tag matching of coded tags may be utilized in the data caches, such as caches 150, 110, or in instruction caches, such as a general instruction cache or trace cache, as described above in reference to FIG. 1. Furthermore, caches implementing direct tag matching of coded tags may be organized in any manger, such as being a physically or logically, centralized or distributed cache. As a specific example, the cache may include a physical centralized cache with a similarly centralized tag directory, such as higher level cache 110. Alternatively, the tag directories may be either physically and/or logically distributed in a physically distributed cache, such as the cache organization illustrated in FIG. 2.

### Embodiments of Coded Tag Matching

In one embodiment, a processor, such as the processor illustrated in FIG. 1, illustrated in FIG. 2, or other processor not illustrated, includes one or more caches capable of directly matching coded tags. Referring to FIG. 3 an embodiment of a cache memory capable of directly matching incoming tags with stored, coded tags is illustrated. Cache 300 includes tag directory 305, data array 310, and cache control mechanism 315. As stated above, cache 300 may include any style cache, such as an instruction cache, data cache, or specialized cache—transactional cache, lock cache, etc. In an embodiment where cache 300 includes an instruction cache, data portion 310 is to hold instructions, whether decoded or not. In contrast, in a data cache data portion 310 is to hold data elements/operands. As illustrated, cache 300 is organized as a two-way (ways 311, 312), set associative cache. Here, the cache includes any number of sets, such 2K sets, with two locations/entries per set. Every unique data address is mapped/associated with a single set, such that a datum is capable of being placed in an entry of either way 311 or 312 within the associated set.

Tag directory 305 includes any structure/logic to hold tag information. Often tag information refers to any information to index into data portion 310. In other words, tag information essentially represents where corresponding data is held in another structure. As a specific illustrative example, tag information includes a tag address, which typically includes a representation of a portion of a virtual or physical address—depending on whether cache 300 is physically or virtually tagged—associated with a data element—cache line or datum—held in data array 310. Continuing the discussion above, cache 300 is depicted as a two way, set associative cache. As a result, tag directory 305 includes two tag ways 306, 307 that correspond to data ways 311, 312, respectively. Consequently, tag entry 308 within way 307 indexes into corresponding data entry 313 within way 312.

Typically, in operation, when an incoming request, which includes an incoming tag, is made to cache 300, tag directory 305 is searched with the incoming tag. If the incoming tag exactly matches tag address 308a held in entry 308, the match indicates a hit—the requested datum is present within corresponding entry 313 of data array 312. As a corollary, if an exact match is not made in tag directory 305, the non-match indicates a miss—the datum is not present in cache 300. However, as described above, caches have begun to implement error detection and/or correction to handle either hard or soft errors that may occur in today's logic circuits.

Therefore, in one embodiment tag address 308a is encoded with error correction codes 308b to form coded tag 308. Here, an error detection/correction algorithm is utilized to generate check values/bits, which are included in tag entry 308 in some manner, such as being appended to tag address 308a. Examples of common algorithms for generating check values include: a parity algorithm, a checksum algorithm, a cyclic redundancy check (CRC) algorithm, and a hash algorithm. Yet, any known algorithm for error detection or correction may be utilized.

Previously, the critical path for a cache access included at least checking if tag address 308a included an error, with a syndrome checker, before performing tag matching of tag address 308a with an incoming tag address of request 301. Additionally, if an error exists, then the error is corrected with a decoder, before the tag matching process. Both of these steps each potentially add delay in the cache lookup process, which the apparatus and methods described herein potentially reduce. Therefore, in one embodiment, cache control mechanism 315 is to perform the tag lookup utilizing coded tag 308—tag address 308a and included ECCs 308b—and a coded version of a tag address from incoming request 301. As a result, stored, coded tag 308 doesn't have to be decoded before comparison.

Here, ECC logic, which is capable of correcting k-bits in a tag and detecting k+1 bit errors in the tag, is to encode an incoming tag from request 301—referred to below as incoming tag 301—to obtain an incoming, coded version of tag 301. For example, ECC logic may compute check bits/values based on incoming tag 301 and append the computed check bits/values to incoming tag 301 to form an incoming, coded version of tag 301. However, any version of including ECC information within or associating ECC information with incoming tag 301 may be used to form a coded tag. Note that stored, coded tag 308 is encoded in the same manner, such that a comparison of the two tags with no errors would provide an exact match.

In one embodiment, instead of performing the previous method of attempting to only find an exact match between stored tag 308a and an incoming tag 301, cache control mechanism 315 is to determine a hit or miss based on a difference or distance between stored, coded tag 308 and an incoming, coded version of tag 301. For example, a tag match—a “hit”—is determined if coded tag 308 and the incoming, coded version of tag 301 is within a hamming distance of each other. For example, the hamming distance between valid codes—coded tags—may be greater than or equal to 2k+2, where k is the number of correctable bits. As specific illustrative examples, in a single-bit error correction and double-bit error detection (SECDED) system the hamming distance between a valid set of bits is at least four, while in a double-bit error correction triple-bit error detection (DECTED) system the hamming distance between a valid set of bits is at least six.

Here, ECC logic within cache control mechanism 315 is to perform the encoding of incoming tag address 301, as discussed above. Therefore, the incoming, coded version of tag address 301 may be directly compared to the stored, coded tag 308. And, even though an exact match indicates a hit with no errors, a non exact match within a distance of 2k+2 may indicate valid codes that include a hit, miss, fault, or other usable information. Difference/comparison logic may also be included in cache control mechanism 315 to determine a difference between an incoming, coded version of tag 301 and stored, coded tag 308. As an example, the difference may be expressed in a number of bits, which is referred to herein as m-bits. In this example, comparison logic, similar to that of a previous match circuit, may be utilized to determine the difference, in bits, of the two coded tags. And, count or adder logic may be utilized to count/add up the number of bits that are different. To provide a further illustration, the comparison logic, in one embodiment, includes compressor logic and adder logic to determine an m-bit difference between the incoming, coded version for tag 301 and stored, coded tag 308. The adder may include any version of an adder circuit, such as a full-adder, a special adder, an optimized adder, and a sparce adder.

Once the m-bit difference is identified, the m-bit difference indicates useful information; such as whether a hit, miss, or fault exists, as well as whether an error is detected in stored, coded tag 308. As an illustrative example, assume ECC logic is capable of correcting k-bits and detecting k+1 bit errors. Here, the m-bit difference represents: (1) a hit with no error when the m-bit difference is equal to zero; (2) a hit with a correctable error when the m-bit difference is less than k-bits; (3) a fault, machine check, or un-correctable error when the m-bit difference is equal to k+1 bits; (4) a miss with a detected error that is not correctable with the incoming, coded version of tag 301 when the m-bit difference is greater than k+1 bits and less than or equal to 2k+1 bits; and (5) a miss with no determination of an error when the m-bit difference is greater than or equal to 2k+2 bits.

The separate levels of division between the aforementioned states based on m-bit differences between tags may be referred to as thresholds. For example, a hit threshold, in this example, may refer to k-bits. In other words, if the m-bit difference is less than or equal to k-bits, then a hit is determined. However, if the m-bit difference is greater than k-bits, there is no hit. Similarly, in the above example, a miss threshold includes k+1 bits. Essentially, if the m-bit difference is greater than k+1, then a miss is determined. Furthermore, there may be thresholds within the hit and miss states. For example, error detection/correction thresholds may exist. Within the hit state, if the m-bit difference is greater than 0-bits—an error threshold—but less than or equal to the k-bit, hit threshold, then a hit determined and an error is detected. In one embodiment, in this hit, error state, the incoming, coded version of tag 301 is utilized to correct stored, coded version of tag 308. As a simple example, the incoming, coded version of tag 301 is written to location 308 within tag directory 305 to replace the previously stored, coded tag 308.

Note that the miss state may include a similar delineation in states, where a threshold—2k+1 bits—differentiates between detecting an error and not detecting an error. If the m-bit difference is less than or equal to the 2k+1 bits, an error is detected. But, because a miss is determined, the incoming, coded version of tag 301 may not be used to cored stored, coded tag 308. Therefore, entry 308 may be marked as having an error detected. Upon an eviction event, such as selecting entry 308—in other words selecting datum held in data array entry 313—for eviction, coded tag 308 is corrected before write-back to a higher-level memory, such as a higher-level cache or system memory.

As can be seen from this example, an incoming, coded tag 301 may be encoded with ECC information and directly compared to stored, coded tag 308, as it's held in tag directory 305. Moreover, this comparison may be done without the delay in the critical path associated with a syndrome checker logic that determines if there is an error and corrects it before a tag match, as was required in previous implementations. In addition, the same information and results—error detection and potential correction—may be gleaned from the comparison that analyzes the difference between the tags, instead of the previous exact match comparison.

It's important to note that the aforementioned thresholds—delineations between a hit, fault, miss, detection of an error, etc—listed in notation based off k correctable bits and k+1 detectable bits is purely illustrative. In fact, any distance, not just a hamming distance, may be utilized to determine whether codes are valid and/or whether a hit, miss, fault, or error occurred. Additionally, even though the previous discussion focused on a single cache organization—tag directory and data array organized in a set associative manner—the methods and apparatus' described herein are not so limited. In fact, the use of directly determining matches between coded tags may be performed in any memory having any organization where one location, which holds coded information, is to be matched against incoming information.

For example, logic may hold a table data structure that is indexed by one column that has a first element of information coded with a second element of information. Upon an incoming request, such as a search of the table, the incoming, first element may be encoded with second element information and directly compared against the entries in the first column. As a result, it's apparent that other cache organizations, such as a direct mapped organization or fully associative organization, may be utilized when implementing the methods and apparatus' described herein. As a corollary to this example, encoded information is not limited ECC information, but may instead include any type of information, such as timestamps, metadata, other data references, etc.

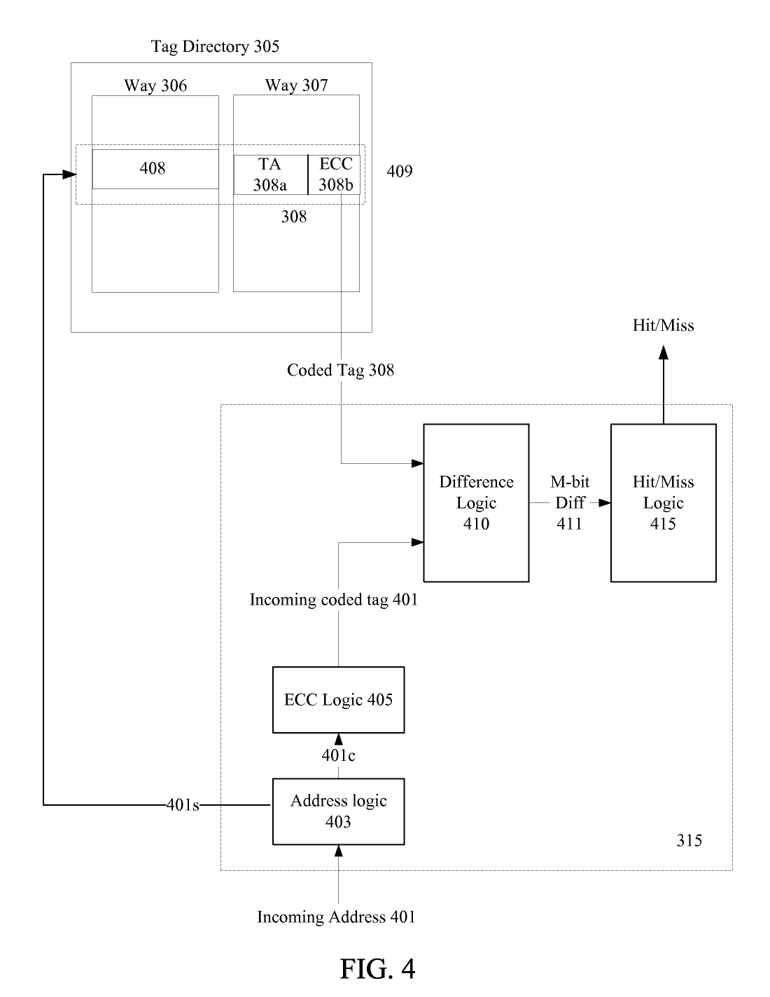

Turning to FIG. 4, an embodiment of logic included with cache control mechanism 315 is illustrated. As before, tag directory 305 is illustrated holding stored, coded tag 308, which includes tag address 308a encoded with Error Correction Codes (ECCs) 308b. As an example, ECCs include check values/bits that are generated by an algorithm based on the values/bits of tag address 308a. In this example, ECC logic 405, in one embodiment, is capable of detecting k+1 bit errors and correcting k bit errors in tag address 308a.

As depicted, address logic 403 is to receive an incoming address, which may be part of an access/request to cache 300. Depending on the cache implementation, incoming address 401 may include a virtual or physical address. Caches may be designed to utilize virtual address tags—virtual tagging—or physical address tags—physical tagging. However, in either implementation, the tag is often a portion of the address utilized as an index, which is described above. Therefore, either through direct manipulation of the incoming address—using a portion of the address—or transformation of at least a portion of the address, address logic 405 obtains incoming tag address 401a.

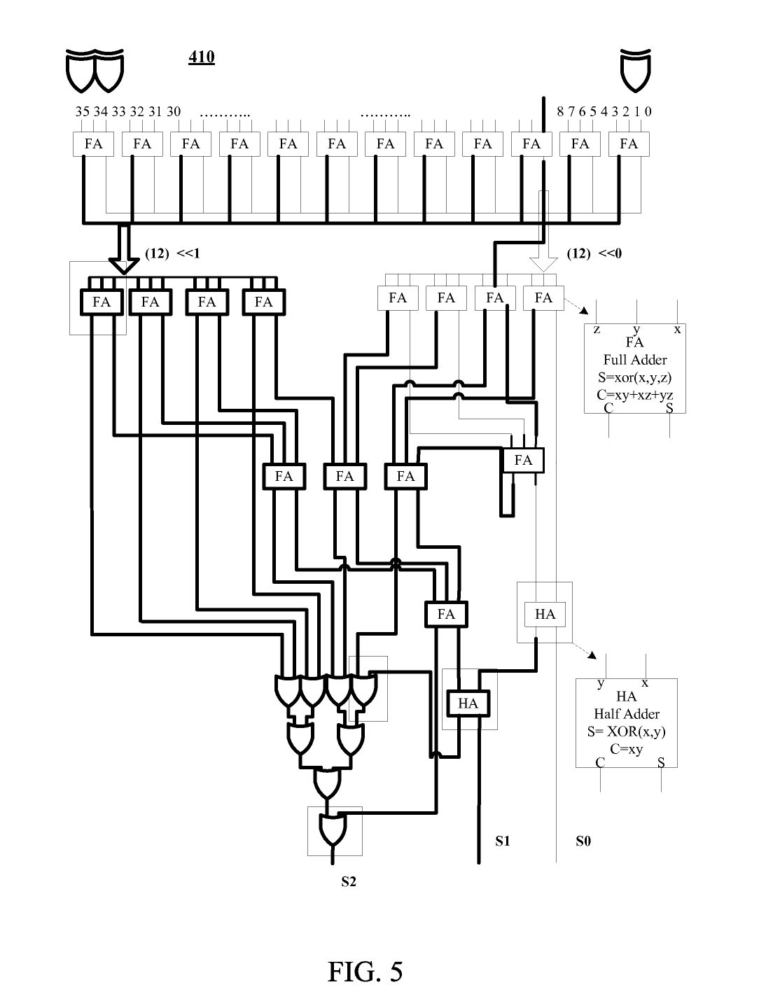

Error Correction Code (ECC) logic receives incoming tag address 401a and encodes it with associated ECCs to obtain incoming, coded tag 401c. As referred to above, when ECC is capable of correcting k-bits and detecting k+1 bit errors, the same algorithm to encode tag 308 is used to encode tag 401c. Note that use of the term logic, in one embodiment, refers to only hardware transistor circuits. However, in another embodiment, logic may refer to hardware, firmware, microcode, or a combination thereof to perform the functions described herein. Other than an exemplary circuit for comparison/difference logic, which is depicted in FIG. 5, other examples and logic are not specifically described to avoid unnecessarily obscuring the discussion. Yet, a person skilled in the art would be able to readily layout the logic to perform the tasks described herein.

In some designs, such as in a set-associative cache, stored tags are identified/determined for comparison. In a fully associative cache, since a tag and datum may be stored in any entry, a search of the tag directory may be performed. However, in the set-associative cache, a unique address is mapped to a set within the cache, such as associating incoming address 401 with set 409. As a result, a tag for incoming address 401 is to be stored within either entry 308 or 408 within set 409. Therefore, when a tag lookup is performed in a set associative cache, only the number of ways within an associated set or group of sets is searched, instead of having to search the entire directory. Here, address logic 403 is able to perform a manipulation or transformation of incoming address, such as taking a portion of incoming address 403 referencing set 409, and index into set 409.

As a result of encoding tag address 401a into coded tag 401c and identifying tag entries 308 and 408, all of the tag address are in the same coded tag format. Therefore, stored, coded tag 308 and incoming, coded tag 401c, in one embodiment, are directly compared. Notice that a syndrome check or ECC decode, in this embodiment, is not performed before the comparison with difference logic 410; this potentially reduces the critical path for the cache lookup.

Difference logic 410 is to determine a difference between incoming, coded tag 401c and the stored, coded tag 308. As discussed above, difference logic 410 may determine the difference as m-bit difference 411 that is provided to hit/miss logic 415. Quickly referring to FIG. 5, an embodiment of difference logic 410 is illustrated. Here compressor logic includes a 3:2 compressor, which may be implemented with an adder circuit, to determine the difference between coded tags in a number of bits (m-bits). Essentially, the compress logic groups bits in sets, such as 3 bits, and determines the difference. Consequently, the compressor tree, in effect, determines the difference of these groups and merges the results. In one embodiment, the depth of the compressor circuit is log(n), where n is the number of input data bits to be compared. Note that the log(n) depth is similar to previous depths of an OR-tree utilized to only provide exact match comparison, as previously discussed. An optimization of this circuit may be employed based on the value of k correctable bits and k+1 detectable bits by ECC; many significant parts of the circuit may be eliminated. For example, if k is equal to one, then only a two-bit output may be utilized.

Here, the optimized circuit becomes similar in complexity to a previous OR-gate tree for exact tag matching. Yet, the results of either the un-optimized or optimized circuit, in one embodiment, are combined utilizing an adder or other count logic, instead of only providing a match or no-match as in the previous implementations. Note that any form of an adder, such as a full adders, sparce adder, simple adder, or an optimized adder may be utilized, as discussed above.

Based on the m-bit difference, hit/miss logic 415 is to determine a result from the tag comparison. As discussed above in reference to FIG. 3, different thresholds may be utilized to determine the result, such as a hit, miss, fault, etc. For example, the hit-miss logic is to determine a hit in response to the m-bit difference being less than or equal to a hit threshold. Or, to determine a miss in response to the m-bit difference being greater than a miss threshold. As a specific illustrative example, assume that ECC logic 405 is capable of DECTED—Double-bit error correction (k) and triple-bit error detection (k+1). In response to the m-bit difference being less than or equal to two-bits—k-bits—a hit is determined. If the m-bits is also greater than 0, then an error is detected. In fact, in this case the error may be correctable utilizing incoming coded tag 401c. Additionally, if the m-bit difference is equal to 3-bits—k+1—then a fault is determined. If the m-bit difference is greater than 3-bits—k+1—then a miss is determined. As above, if the m-bit difference is greater than 3-bits and less than or equal to 5 bits—2k+1—then an error is detected. However, in this scenario, the stored, coded tag 308 is not correctable using the incoming, coded tag 401c. In contrast, the stored, coded tag 308 may be corrected utilizing traditional decoder logic upon an eviction and write-back to higher-level memory. In another scenario, if the m-bit difference is greater than or equal to 6-bits—2k+2 —a miss is determine and no error is detectable. Therefore, not only is coded, stored tag 308 able to be directly compared with incoming, coded tag 401c, the determination of a hit, miss, fault, and/or potential error may be performed without the longer critical path associated with checking and correcting tag information before a comparison.

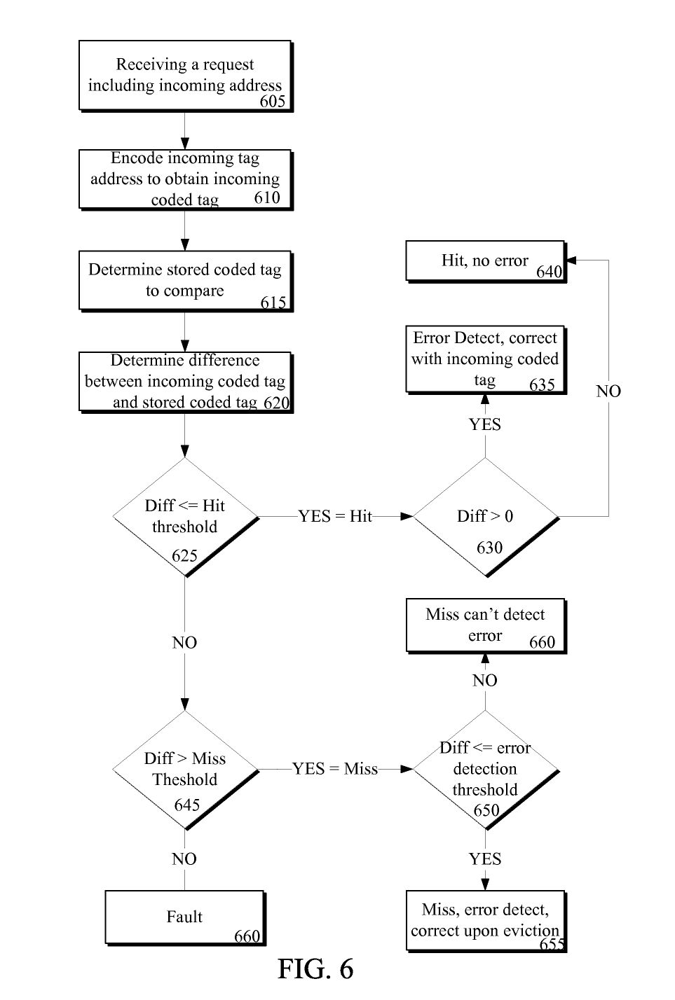

Turning next to FIG. 6 an embodiment of a flow diagram for a method of directly matching coded tags is illustrated. Although the flows of FIG. 6 are illustrated in a substantially serial fashion, each of the flows may be performed at least partially in parallel or in a different order. Furthermore, some of the illustrated flows may be omitted, while other flows may be included in different embodiments. For example, determining a stored, coded tag to compare in flow 615 may be performed at least partially in parallel with encoding incoming tag address in flow 610. Furthermore, any of the threshold determinations—flows 625, 645, 630, 650—may be done in parallel or in a different order.

In flow 605, a request including an incoming address is received. The request may include a read, a write, or any other known cache access. In flow 610 an incoming tag address, which may associated with or part of the incoming address, is encoded to obtain an incoming, coded tag. Here, an ECC operation or algorithm may be performed on the tag address to compute check bits/values that are then associated with the tag address to form the incoming, coded tag. As an example, computed ECCs are appended to the tag address to obtain the incoming, coded tag.

In flow 615, a stored, coded tag is determined to compare with the incoming, coded tag. Any known method of determining a tag to compare may be utilized. As an example, a portion of the incoming address is utilized to index into a set, or a group of sets, that include the stored, coded tag. From there, the ways within the set are selected for comparison, where one of the ways includes the stored, coded tag as an entry within the set. This example pertains mostly to a set-associative cache. However, similar methods may be utilized for fully associative or direct mapped caches.

In flow 620, a difference between the incoming coded, tag and the stored, coded tag is determined. Here, comparison logic, such as the compressor logic in FIG. 5, or other known logic that may determine a difference between two addresses or sets of bits, may be used. Furthermore, the difference, in bits, may be counted/added to obtain an m-bit difference between the incoming, coded tag and the stored, coded tag.

Once the difference is obtained, a hit or miss may be determined based on the m-bit difference. As an example, take a SECDED-single-bit error correction and double-bit error detection—system, where k=1 and k+1=2. Here, if the m-bit difference is less than or equal to a hit threshold—1-bit (k-bits)—then a hit is determined from flow 625. In flow 630, if the m-bit difference is also greater than zero, then in addition to the hit, an error has been detected in flow 635. The error, in this case, may be correctable by busing the incoming, coded tag address. Yet, if there m-bit difference is zero, then there is no error associated with the hit.

In flow 645, if the m-bit difference is not greater than a miss threshold—2-bits (k+1)—then the only possible m-bit error left is a 2-bit or k+1 bit error. This determination results in a fault or machine check as an uncorrectable error is determined. However, if the m-bit error is greater than 2-bits—the miss threshold—then a miss is determined. Furthermore, if the m-bit error is also less than or equal to an error diction threshold of 3-bits—2k+1—then an error is detected. Because of the miss determination, the incoming, coded tag is not able to correct the error. However, upon eviction and before write-back, the stored, coded tag may be corrected utilizing decode logic to decode the encoded ECC check bits and correct the tag address based thereon. Alternatively, if the m-bit error is greater than three bits—2k+1—a miss is determined but no error is detectable in this example.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical storage device, optical storage devices, acoustical storage devices or other form of propagated signal (e.g., carrier waves, infrared signals, digital signals) storage device; etc. For example, a machine may access a storage device through receiving a propagated signal, such as a carrier wave, from a medium capable of holding the information to be transmitted on the propagated signal.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a cache tag directory to include a tag entry to hold a coded tag, wherein the coded tag is to include tag information and error correction codes (ECCs); and
a cache control mechanism coupled to the tag directory, the cache control mechanism, in response to a cache access including incoming tag information, to encode the incoming tag information with ECCs to obtain a coded, incoming tag; and to directly determine if a hit exists between the incoming, coded tag and the coded tag to be held in the tag entry.

2. The apparatus of claim 1, wherein the tag information includes a tag address, the incoming tag information includes an incoming tag address, and the ECCs include ECC values.

3. The apparatus of claim 1, wherein the cache control mechanism comprises error correction code (ECC) logic to encode the incoming tag information with ECCs, and wherein the ECC logic is capable of correcting k bits of a coded tag address and detecting k+1 bits of a coded tag address, wherein k includes an integer value that is greater than or equal to zero.

4. The apparatus of claim 3, wherein the cache control mechanism further comprises difference logic to directly determine a difference, in a number of bits, between the incoming, coded tag and the coded tag.

5. The apparatus of claim 4, wherein the cache control mechanism further comprises hit-miss logic to directly determine if a hit exists between the incoming, coded tag and the coded tag to be held in the tag entry, and wherein the hit-miss logic to determine if a hit exists between the incoming, coded tag and the coded tag comprises:
the hit-miss logic to determine a hit exists between the incoming, coded tag and the coded tag in response to the difference between the incoming, coded tag and the coded tag being less than or equal to k bits; and
the hit-miss logic to determine a hit does not exist between the incoming, coded tag and the coded tag in response to the difference between the incoming, coded tag and the coded tag being greater than k bits.

6. The apparatus of claim 5, wherein the hit-miss logic is further to determine that an error exists in the coded tag in response to the difference between the incoming, coded tag and the coded tag being greater than zero bits and less than or equal to k bits.

7. The apparatus of claim 6, wherein the ECC logic is to correct the coded tag to be held in the tag entry with the incoming, coded tag in response to the hit-miss logic determining that an error exists in the coded tag in response to the difference between the incoming, coded tag and the coded tag being greater than zero bits and less than or equal to k bits.

8. The apparatus of claim 5, wherein the hit-miss logic is further to determine a miss exists between the incoming, coded tag and the coded tag in response to the difference between the incoming, coded tag and the coded tag being more than k+1 bits.

9. The apparatus of claim 8, wherein the hit-miss logic is further to determine that an error exists in the coded tag in response to the different between the incoming, coded tag and the coded tag being greater than k+1 bits and less than or equal to 2k+1 bits.

10. The apparatus of claim 9, wherein the ECC logic, responsive to an eviction event associated with the tag entry, is to perform error correction on the coded tag before a write-back of the coded tag to a higher-level memory.

11. The apparatus of claim 8, wherein the hit-miss logic is further to determine a fault in response to the different being equal to k+1 bits.

12. The apparatus of claim 4, wherein the difference logic comprises comparison logic to determine a number of bits different between the incoming, coded tag and the coded tag; and count logic coupled to the comparison logic to count the number of bits different between the incoming, coded tag and the coded tag.

13. The apparatus of claim 12, wherein comparison logic comprises a compressor tree, and wherein the count logic comprises a circuit selected from a group consisting of an adder-circuit, a sparce-adder circuit, and an optimized adder circuit.

14. The apparatus of claim 5, wherein cache tag directory and the cache control mechanism are included within a microprocessor, the microprocessor to be coupled to a memory, wherein the memory is to be selected from a group consisting of a Dynamic Random Access Memory (DRAM), Double Data Rate (DDR) RAM, and a Static Random Access Memory (SRAM).

15. An apparatus comprising: a processor including,
a cache tag directory to hold a stored, coded tag, wherein the stored, coded tag is to include a stored tag address and associated error correction codes (ECCs);
error correction code (ECC) logic to receive an incoming tag address and to encode the incoming tag address with associated ECCs to obtain an incoming, coded tag;
difference logic coupled to the ECC logic and the tag directory, the difference logic to determine a difference between the incoming, coded tag line and the stored, coded tag line; and
hit-miss logic coupled to the difference logic, the hit-miss logic to determine a hit in response to the difference being less than or equal to a hit threshold.

16. The apparatus of claim 15, wherein the ECC logic is capable of correcting k-bits in the stored tag address and capable of detecting k+1 bit errors in the stored tag address.

17. The apparatus of claim 15, wherein the difference between the incoming, coded tag line and the stored, coded tag line comprises an m bit difference.

18. The apparatus of claim 17, wherein the difference logic comprises compressor logic and an adder logic to determine the m bit difference between the incoming, coded tag line and the stored, coded tag line.

19. The apparatus of claim 17, wherein the hit threshold includes a k bit threshold, and wherein the hit-miss logic is to determine a hit in response to the m bit difference being less than or equal to the k bit threshold.

20. The apparatus of claim 19, wherein the ECC logic is to correct the stored, coded tag in response to the m bit difference being less than or equal to the k bit threshold and greater than zero.

21. The apparatus of claim 17, wherein the hit-miss logic is further to determine a miss in response to the m bit difference being greater than a miss threshold.

22. The apparatus of claim 21, wherein the miss threshold comprises k+1 bits.

23. The apparatus of claim 22, wherein the ECC logic, responsive to an eviction event associated with the stored, coded tag, is to correct the stored, coded tag before write-back to a higher-level memory in response to the m bit difference being greater than k+1 bits and less than or equal to 2k+1 bits.

24. The apparatus of claim 22, wherein the hit-miss logic is to generate a fault in response to the m bit difference being equal to k+1 bits.

25. The apparatus of claim 15, wherein the cache tag directory, the ECC logic, the difference logic, and the hit-miss logic are included within a microprocessor, the microprocessor to be coupled to a memory, wherein the memory is to be selected from a group consisting of a Dynamic Random Access Memory (DRAM), Double Data Rate (DDR) RAM, and a Static Random Access Memory (SRAM).

26. A method comprising:
receiving a cache memory request referencing an incoming address including an incoming tag address;
encoding the incoming tag address with error correction codes (ECCs) to obtain an incoming, coded tag in response to receiving the cache memory request;
determining a stored, coded tag based on at least a portion of the incoming address in response to receiving the cache memory request;
determining a difference between the stored, coded tag and the incoming, coded tag in response to encoding the incoming tag address with ECCs to obtain the incoming, coded tag and determining the stored, coded tag; and
determining a miss in response to the difference being greater than a miss threshold.

27. The method of claim 26, wherein determining the store, coded tag based on at least the portion of the incoming address comprises indexing into a set of a tag directory based on at least the portion of the incoming address, wherein the set is to include the stored, coded tag.

28. The method of claim 26, wherein the difference comprises an m-bit difference, and wherein the miss threshold comprises k+1 bits.

29. The method of claim 26, wherein the difference comprises an m-bit difference, and wherein the miss threshold comprises k+1 bits.

30. The method of claim 29, further comprising correcting the store, coded tag, responsive to an eviction event associated with the stored, coded tag and further responsive to the m-bit difference being greater than k+1 bits and less than or equal to 2k+1 bits.

31. The method of claim 28, further comprising determining a hit in response to the m-bit difference being less than or equal to k bits.

32. The method of claim 31, further comprising correcting the stored, coded tag with the incoming, coded tag in response to the m-bit difference being less than or equal to k bits and greater than zero.

33. An apparatus comprising means for performing the method of claim 26.
